(19) United States
(12) Patent Application Publication
(10) Pub. No.: US 2026/0239508 A1
(43) Pub. Date: Aug. 13, 2026

(54) MULTIFUNCTIONAL SAFETY INDICATOR LIGHT CIRCUIT

(71) Applicant: Je Woo Corporation, Ltd., Huizhou (CN)

(72) Inventors: Chenggen LI, Huizhou (CN); Huashui CHEN, Huizhou (CN)

(21) Appl. No.: 19/251,878

(22) Filed: Jun. 27, 2025

(30) Foreign Application Priority Data
Feb. 8, 2025 (CN) 202520197832.0

(51) Int. Cl. H05B 45/54; H05B 45/24; H05B 45/345

(52) U.S. Cl. CPC H05B 45/54; H05B 45/24; H05B 45/345

(57) ABSTRACT

A multifunctional safety indicator light circuit, including: an emergency indicator unit, a power supply circuit, a mode selector switch, a test unit, and a control unit. The power supply circuit includes an AC power input terminal, a battery circuit, a switching circuit for switching power supply between the AC power input terminal and the battery circuit, and a discharging circuit for discharging the battery circuit. The mode selector switch includes a continuous test mode terminal, a manual test mode terminal, an AC indication mode terminal and a common terminal. The test unit includes a detection circuit connected to the emergency indicator unit and a manual test switch for manually triggering a test. The control unit includes a timer and a plurality of terminals; the detection circuit and the manual test switch are connected to a first terminal and a second terminal of the control unit, respectively.

### CROSS-REFERENCE TO RELATED APPLICATIONS

Pursuant to 35 U.S.C.§ 119 and the Paris Convention Treaty, this application claims foreign priority to Chinese Patent Application No. 202520197832.0 filed Feb. 8, 2025, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of emergency lighting, and more particularly to a multifunctional safety indicator light circuit.

Safety indicator lights, also known as emergency evacuation indicator lights, are safety devices widely used in public areas. The primary function of the safety indicator lights is to provide illumination and evacuation guidance in the event of a main lighting power outage, ensuring the safe and prompt evacuation from hazardous areas.

However, traditional safety indicator lights present the following technical deficiencies:

1. Limited functionality. Most traditional safety indicator lights only offer basic emergency lighting functionality, lacking self-checking and fault diagnosis capabilities. This makes it difficult to promptly detect lamp or battery failures, posing safety risks.

2. Maintenance challenges. Traditional safety indicator lights require regular manual inspections and testing to ensure proper operation, resulting in heavy maintenance workloads, low efficiency, and potential oversight risks.

### SUMMARY

To solve the abovementioned problems, the disclosure provides a multifunctional safety indicator light circuit, comprising: an emergency indicator unit, a power supply circuit, a mode selector switch, a test unit, and a control unit. The power supply circuit comprises an AC power input terminal, a battery circuit, a switching circuit for switching power supply between the AC power input terminal and the battery circuit, and a discharging circuit for discharging the battery circuit. The mode selector switch comprises a continuous test mode terminal, a manual test mode terminal, an AC indication mode terminal, and a common terminal. The test unit comprises a detection circuit connected to the emergency indicator unit and a manual test switch for manually triggering a test. The control unit comprises a timer and a plurality of terminals; the detection circuit and the manual test switch are connected to a first terminal and a second terminal of the control unit, respectively; the common terminal of the mode selector switch is connected to a third terminal of the control unit; and the continuous test mode terminal, the manual test mode terminal, and the AC indication mode terminal are connected to different input pins or specific levels of the control unit, respectively.

When the mode selector switch is set to the continuous test mode terminal, the control unit periodically activates the detection circuit through the timer to monitor a status of the emergency indicator light unit; when the mode selector switch is set to the manual test mode terminal, the control unit, upon detecting a signal from the manual test switch, triggers the switching circuit to shift to battery power and activates the detection circuit to monitor a status of the emergency indicator light unit; and when the mode selector switch is set to the AC indication mode terminal, the control unit controls the switching circuit to turn off the battery circuit.

In a class of this embodiment, a pull-up resistor is disposed between the third terminal of the control unit and the common terminal of the mode selector switch; the continuous test mode terminal is grounded; the AC indication mode terminal is connected to a fourth terminal of the control unit; between the AC indication mode terminal and the fourth terminal of the control unit, a first resistor and a first capacitor are connected in series to ground; and the manual test mode terminal is electrically connected to the third terminal of the control unit and grounded through a second resistor and a second capacitor connected in series.

The pull-up resistor, ground connections, and resistor-capacitor (RC) networks are utilized to provide distinct voltage level combinations at the input pins of the control unit. When the mode selector switch is set to different positions, the corresponding pins of the control unit exhibit high levels, low levels, or specific voltage transitions. By detecting these level combinations, the control unit can accurately determine the operating mode selected by a user and thus control the circuit to perform the corresponding functions.

In a class of this embodiment, the emergency indicator light unit comprises a plurality of bi-color LED lamps and a color toggle switch;

each of the bi-color LED lamps comprises a first color end, a second color end, and a first common end;

the color toggle switch comprises a first end, a second end, and a second common end;

the first color end of each of the plurality of bi-color LED lamps is connected to the first end of the color toggle switch;

the second color end of each of the plurality of bi-color LED lamps is connected to the second end of the color toggle switch;

the first common end of each of the plurality of bi-color LED lamps is connected to the power supply circuit; and

the second common end of the color toggle switch is grounded.

The use of the bi-color LED lamps and the color toggle switch enables the safety indicator lamp to display different colors, such as red and green, as needed, expanding the application scenarios of the indicator lamp and enhancing the diversity of indication information. Centralized control of the color selection of the bi-color LEDs through the color toggle switch simplifies the control logic and reduces the circuit complexity.

In a class of this embodiment, each of the bi-color LED lamps comprises a red LED lamp and a green LED lamp, and the red LED lamp and the green LED lamp are operatively connected in series with a current-limiting resistor.

The current limiting resistor is connected in series with each red LED and green LED, which can effectively limit the current flowing through the LEDs, preventing the LEDs from being damaged by overcurrent, prolonging the service life of the LEDs, and improving the circuit reliability.

In a class of this embodiment, the switching circuit comprises a first switching element and a second switching element;

the first switching element is operatively coupled to the AC power input terminal and configured to control power supply from the AC power input terminal to the circuit;

the second switching element is operatively coupled to the battery circuit and configured to control power supply from the battery circuit to the circuit; and

the control unit is programmed to selectively activate or deactivate the first switching element and the second switching element, thereby achieving a power supply switchover between the AC power input terminal and the battery circuit.

The first switching element and the second switching element are used to control the power supply from the AC power source and the battery circuit, respectively, to realize the automatic switching of the power source. The control unit controls the conduction and shutdown of the two switching elements according to different operating modes, ensuring automatic switching to the battery power supply when the AC power supply is cut off, ensuring the continuous working ability of the safety indicator, and improving its reliability in emergency situations.

In a class of this embodiment, the detection circuit comprises a resistor divider disposed between the emergency indicator unit and ground; and the first terminal of the control unit is electrically connected to a midpoint node of the resistor divider.

By incorporating the resistor divider into the detection circuit, the working status of the emergency indicator light unit can be easily detected. The resistor divider is connected between the emergency indicator light unit and the ground. The control unit can determine whether the LED is functioning properly by detecting the voltage at the midpoint node of the resistor divider, thereby achieving fault detection of the indicator light module.

In a class of this embodiment, the resistor divider comprises a third resistor and a fourth resistor; the third resistor comprise a first end connected to the emergency indicator unit and a second end connected to the first terminal of the control unit; and the fourth resistor comprise a third end connected to the emergency indicator unit and a fourth end which is grounded.

Reasonable selection of the resistance values of the third resistor and the fourth resistor can set the appropriate detection voltage range, so that the control unit can accurately detect the state changes of the emergency indicator unit, improving the sensitivity and reliability of the detection circuitry.

In a class of this embodiment, both the first switching element and the second switching element are a p-channel metal-oxide-semiconductor field effect transistor (MOSFET);

a source of the first switching element is connected to the AC power input terminal through a first diode, a drain of the first switching element is connected to a power supply terminal of the circuit, and a gate of the first switching element is connected to a first control circuit;

a source of the second switching element is connected to a positive terminal of the battery circuit through a second diode, a drain of the second switching element is connected to the power supply terminal of the circuit, and a gate of the second switching element is connected to a second control circuit; and

the first control circuit and the second control circuit are configured to activate or deactivate the first switching element and the second switching element, respectively, in response to control signals from the control unit.

P-channel MOSFETs have advantages such as low on resistance and fast switching speed, making them suitable for power switching circuits. By connecting the source of the P-channel MOSFET to the AC power input terminal and the battery circuit, the drain to the power supply terminal of the circuit, and the gate to the control circuit, the conduction and turn off of the switching element are controlled by controlling the gate voltage, thereby achieving fast and reliable switching of the power supply and ensuring stable operation of the safety indicator light in different power supply modes.

In a class of this embodiment, the first control circuit comprises a first NPN transistor; a collector of the first NPN transistor is electrically connected to the gate of the first switching element; an emitter of the first NPN transistor is grounded; and a base of the first NPN transistor is connected via a fifth resistor to both an output terminal of the control unit and the AC power input terminal;

the second control circuit comprises a second NPN transistor; a collector of the second NPN transistor is electrically connected to the gate of the second switching element; an emitter of the second NPN transistor is grounded; a base of the second NPN transistor is connected via a sixth resistor to both the output terminal of the control unit and the positive terminal of the battery circuit;

when a voltage is present at the AC power input terminal, the first NPN transistor is activated, pulling a gate voltage of the first switching element to a low logic level, thereby activating the first switching element, and the AC power input terminal supplies power to the circuit via the first diode and the first switching element;

when the AC power input terminal is de-energized, the first NPN transistor is deactivated, pulling the gate voltage of the first switching element up to a high logic level, thereby deactivating the first switching element; and

when the control unit transmits a signal to activate the second NPN transistor, a gate voltage of the second switching element is pulled down to a low logic level, thereby activating the second switching element; and the battery circuit supplies power to the circuit via the second diode and the second switching element.

By regulating the base voltage of the NPN transistor, its conduction (ON) and cutoff (OFF) states can be controlled, thereby indirectly adjusting the gate voltage of the P-channel MOSFET (P-MOSFET) to achieve precise power source switching. When a voltage is present at the AC power input, the first NPN transistor is turned on, pulling the gate of the first P-MOSFET to a low voltage. This activates the P-MOSFET, enabling AC power supply to the circuit. If AC power is removed, the first NPN transistor turns off, and the first switching element cuts off. To switch to battery power, the control unit drives the second NPN transistor to conduct. This pulls down the gate voltage of the second P-MOSFET, turning it on and enabling battery-powered operation. This control method has a clear logical flow and fast response, which ensures the reliability and stability of power switching.

In a class of this embodiment, the discharging circuit comprises a third switching element disposed between the source of the second switching element and a load, and a fourth switching element for activating or deactivating the third switching element;

a control terminal of the fourth switching element is connected to an output terminal of the control unit, and a control terminal of the third switching element is connected to an output terminal of the fourth switching element through a seventh resistor; and

to discharge the battery circuit, the control unit activates the fourth switching element, thereby activating the third switching element, and a battery discharge path is established.

The following advantages are associated with the multifunctional safety indicator light circuit of the disclosure.

The multifunctional safety indicator circuit of the disclosure enables flexible selection of different operating modes, including an automatic detection mode, a manual testing mode, and an AC indication mode, by means of a mode selector switch. In the automatic detection mode, the control unit utilizes a built-in timer to automatically detect the status of the indicator module at regular intervals without manual intervention, which improves the maintenance efficiency and reduces the maintenance cost; in the manual test mode, the user can trigger the battery power supply and the detection circuit to work by means of a manual test switch, which facilitates a quick check of whether the indicator is functioning correctly; and in the AC indication mode, the battery circuit is turned off and only the AC power supply is used for indication. The circuit of the disclosure has the advantages of diversified functions, intelligent and convenient testing and flexible use, overcoming the problems of single function and inconvenient maintenance of the safety indicator light in the prior art, and improving the reliability and practicability of the safety indicator light.

### BRIEF DESCRIPTION OF THE DRAWINGS

FIG. 1 is a circuit diagram of an emergency indicator unit, a switching circuit, and a detection circuit according to one embodiment of the disclosure;

FIG. 2 is a circuit diagram of a control unit and a mode selector switch according to one embodiment of the disclosure;

FIG. 3 is a circuit diagram of an AC power detection circuit according to one embodiment of the disclosure;

FIG. 4 is a circuit diagram of a programming interface circuit according to one embodiment of the disclosure;

FIG. 5 is a circuit diagram of a battery charge/discharge enable circuit according to one embodiment of the disclosure;

FIG. 6 is a circuit diagram of a first control circuit according to one embodiment of the disclosure;

FIG. 7 is a circuit diagram of a second control circuit according to one embodiment of the disclosure;

FIG. 8 is a circuit diagram of an emergency indicator unit according to one embodiment of the disclosure; and

FIG. 9 is a circuit diagram of a discharging circuit according to one embodiment of the disclosure.

### DETAILED DESCRIPTION

To further illustrate the disclosure, embodiments detailing a multifunctional safety indicator light circuit are described below. It should be noted that the following embodiments are intended to describe and not to limit the disclosure.

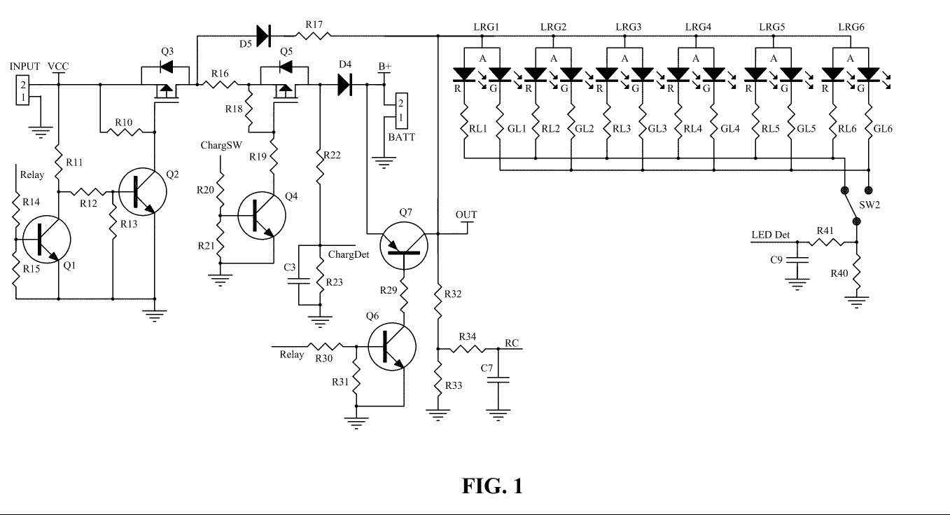

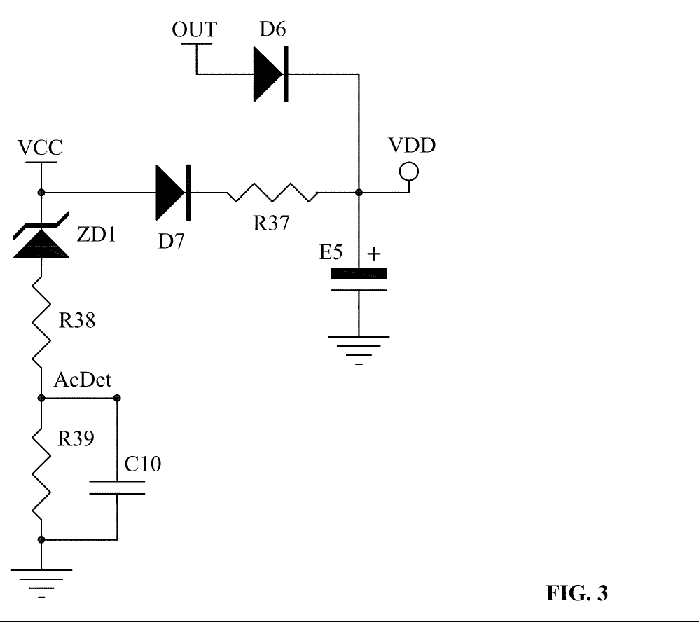

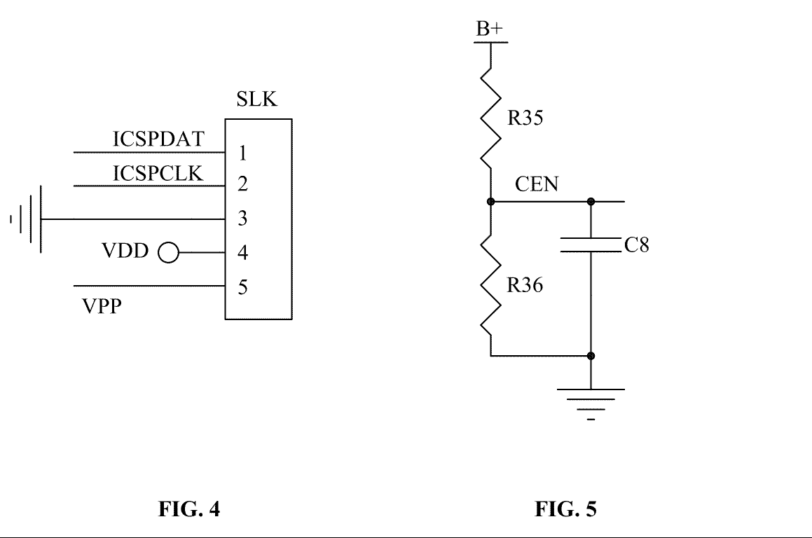

As shown in FIGS. 1-9, the disclosure provides a multifunctional safety indicator light circuit comprising an emergency indicator unit, a power supply circuit, a mode selector switch SW3, a test unit, and a control unit U2.

### 1. Emergency indicator unit

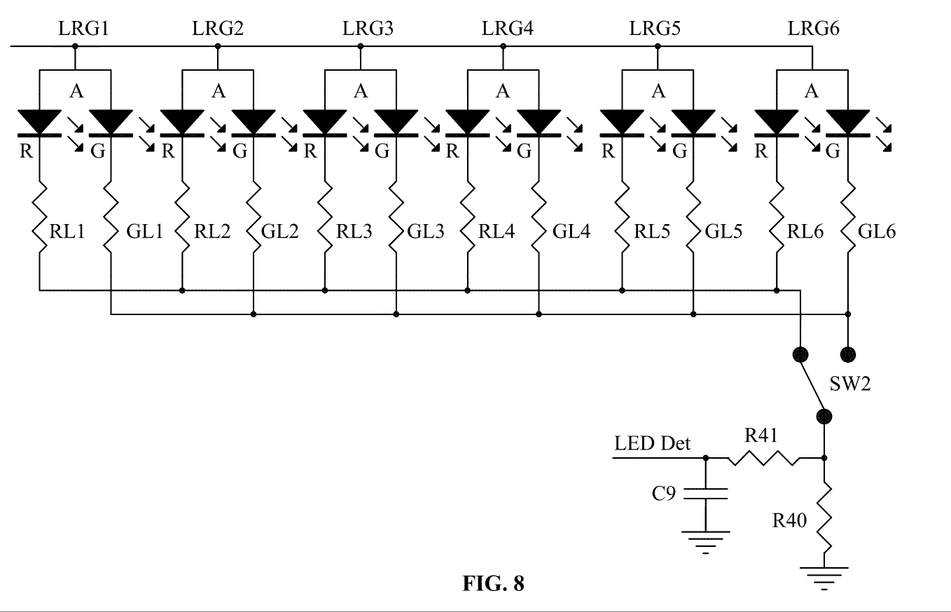

As shown in FIG. 8, in one embodiment, the emergency indicator unit comprises a plurality of bi-color LEDs (LRG1-LRG6) and a color toggle switch SW2. Each of the plurality of bi-color LEDs comprises a red LED (RL1-RL6) and a green LED (GL1-GL6), and the red LED and the green LED can be switched to display as needed to provide different warning or indication information.

The negative terminal of each red LED (RL1-RL6) is serially connected with a first current-limiting resistor and subsequently connected to one fixed terminal of the color toggle switch SW2. The resistance value of the current-limiting resistors is determined based on the rated operating current of the red LEDs and the supply voltage, thereby ensuring proper LED operation and preventing overcurrent damage.

The negative terminal of each green LED (GL1-GL6) is serially connected with a second current-limiting resistor and coupled to the other fixed terminal of the color toggle switch SW2. The resistance value of these current-limiting resistors is determined based on the rated operating current of the green LEDs and the supply voltage.

All positive terminals of both red and green LEDs are commonly connected to the output terminal VCC of the power supply circuit, serving as the power delivery node for the LED array.

The color toggle switch SW2 employs a single-pole double-throw (SPDT) switch with its common end grounded. Users can toggle SW2 to electrically connect the common end to either the negative terminal of the red LED light or the negative terminal of the green LED light, thus choosing to light up the red LED light or the green LED light.

### 2. Power supply circuit

The power supply circuit comprises an AC power input terminal (INPUT), a battery circuit (BATT), a switching circuit, a discharging circuit, and an AC power detection circuit (AcDet).

The AC power input terminal (INPUT) is connected to an external AC power source to supply operational voltage to the circuit. The AC power undergoes rectification and filtering processes and is subsequently converted into DC voltage for circuit operation.

The battery circuit (BATT) provides emergency power supply during AC power outages, ensuring uninterrupted operation of the safety indicator light. The battery circuit typically incorporates a rechargeable battery and a protection circuit.

The switching circuit is configured to switch the power supply between the AC power input terminal and the battery circuit.

In the embodiment, the switching circuit comprises a first switching element Q3 (P-channel MOSFET) and a second switching element Q5 (P-channel MOSFET).

The source of the first switching element Q3 is connected to the AC power input terminal (after rectification and filtering) via a first diode D5; the drain is connected to the power supply terminal VCC of the circuit, and the gate is connected to a first control circuit. The function of the first diode D5 is to prevent the battery voltage from backing up to the AC power input terminal.

The source of the second switching element Q5 is connected to the positive terminal of the battery circuit through a second diode D4; the drain is connected to the power supply terminal VCC of the circuit, and the gate is connected to a second control circuit. The function of the second diode D4 is to prevent the AC power supply voltage from backing up to the battery.

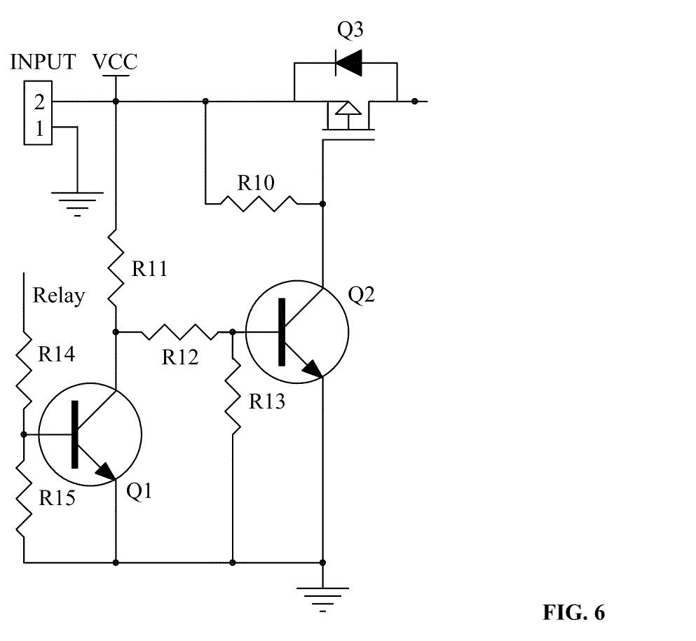

As shown in FIG. 6, the first control circuit comprises a first NPN transistor Q1, a second NPN transistor Q2, and resistors R10, R11, R12, R13, R14, and R15. The collector of Q2 is connected to the gate of Q3, the emitter is grounded, and the base is connected to the collector of Q1 through the resistor R12. The base is also connected to VCC through the resistor R11, and the base is also connected to ground through the resistor R13. The base of Q1 is connected to the RC3 (Relay) pin of the control unit U2 through R14, the emitter is grounded, and the collector is connected to the base of Q2 through R12. R10 is connected between the gate of Q3 and VCC as a pull-up resistor for the Q3 gate. R15 is connected between the base of Q1 and ground.

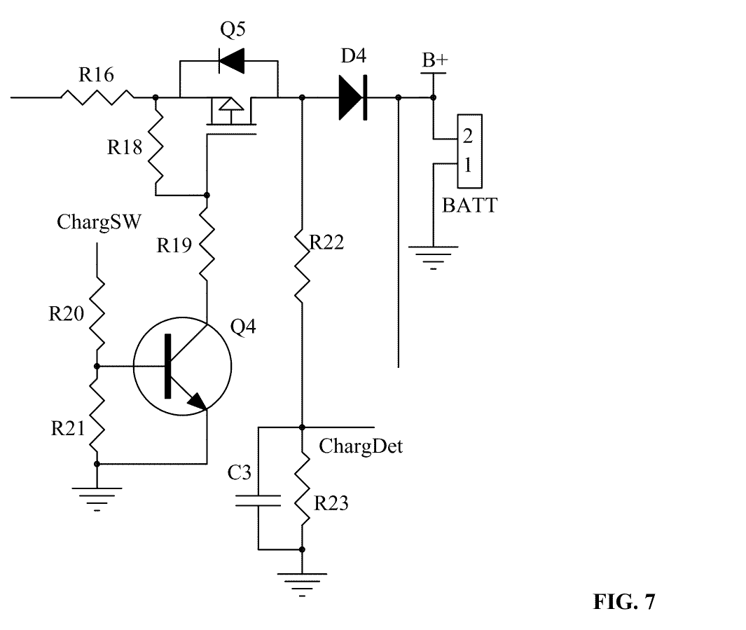

As shown in FIG. 7, the second control circuit comprises a third NPN transistor Q4 and resistors R18, R19, R20, and R21. The collector of Q4 is connected to the gate of Q5, the emitter is grounded, and the base is connected to the output terminal of the ChargSW (RA0) of the control unit U2 through the resistor R20. The base of Q4 is also connected to the gate of Q5 through the resistor R19. The base of Q4 is also connected to the output terminal of the battery circuit through the resistors R22 and R23 for battery voltage detection (ChargDet,RA3). The positive terminal of the battery B+ is connected to the CEN (RA1) pin through the resistor R35 and is grounded through the resistor R36 and a capacitor C8.

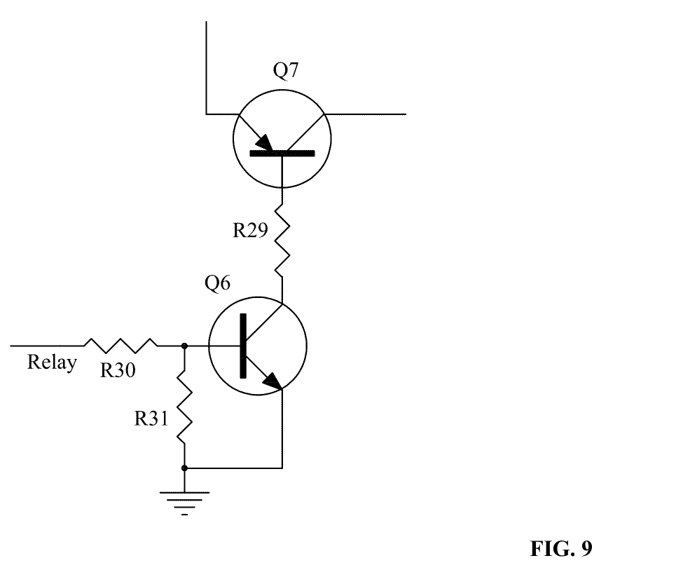

The discharge circuit is configured to perform discharge testing on the battery circuit under the control of the control unit U2. As shown in FIG. 9, the discharge circuit comprises Q6, Q7, R29, R30, R31, R32, and a RC charging and discharging circuit (R33, R34, C7).

Q6 (NPN transistor) serves as a control switch for the discharge circuit. The base of the transistor is connected to the “Relay” (RC3) output terminal of the control unit U2 through the resistor R30, the collector is connected to the base of Q7 through the resistor R29, and the emitter is grounded through the resistor R31.

Q7 (PNP transistor) is used as a discharge tube. The emitter of the transistor is connected to VCC, and the collector is connected to the RC charging and discharging circuit through the resistor R32.

R32, R33, R34, and C7 form the RC charging and discharging circuit, which is connected to the RC (10 pin) pin of the control unit U2. One end of R32 is connected to the collector of Q7, and the other end is connected to the RC (10 pin) pin of R34 and the control unit U2. One end of R34 is connected to R32, and the other end is connected to R33 and the RC (10 pin) pin of the control unit U2. One end of R33 is connected to the RC (10 pin) pin of R34 and the control unit U2, and the other end is grounded. One end of C7 is connected to the RC (10 pin) pin of the control unit U2 and the connection point of R34 and R33, and the other end is grounded.

The AC power detection circuit is used to check whether the AC power supply is supplying power normally. The detection result is output to the RC4 (AcDet) pin of the control unit U2. The AC power detection circuit mainly comprises a Zener diode ZD1, resistors R38, R39, and a capacitor C10.

The negative terminal of the Zener diode ZD1 is connected to VCC and the positive terminal is connected to the resistor R38. The voltage regulation value of ZD1 is selected based on the voltage of VCC and the input level requirements of the control unit U2.

The current limiting resistor R38 protects ZD1 from overcurrent damage.

The pull-down resistor R39 is connected to the RC4 (AcDet) pin of the control unit U2.

The filter capacitor C10 is connected in parallel with R39 to filter out the voltage fluctuations on the RC4 (AcDet) pin.

The freewheeling diode D7 is used to provide a current path during the shutdown or switching process. The anode of the freewheeling diode is connected to one end of R37 and the positive electrode of ZD1, and the cathode thereof is connected to VCC.

The protective diode D6 is used to prevent voltage reversal or exceeding drain voltage (VDD). The anode of the protective diode is grounded and the cathode thereof is connected to VDD.

The current limiting resistor on the other end of R37 is connected to VDD.

E5 is a capacitor with its positive terminal connected to the positive terminal of the battery and its negative terminal connected to the ground, which serves as a filter.

The working principle of the power supply circuit is detailed as follows:

AC power supply: when a voltage is present at the AC input terminal, after rectification and filtering, the processed voltage is, on one hand, supplied to the circuit (VCC), and on the other hand, is applied to the base of Q2 through the resistor R11, biasing Q2 into conduction. When the Q2 is conductive, the gate of Q3 is pulled down, and since Q3 is a P-channel MOSFET, the low level of the gate causes Q3 to conduct, and the AC power supply supplies power to the circuit (VCC) through D5 and Q3. Simultaneously, the control unit U2 detects AC power status via the RC4 (AcDet) pin, controls ChargSW (RA0) to output at logic-low, rendering Q4 and Q5 non-conductive (battery circuit disabled). The control unit U2 also controls the output of RC3 (Relay) pin according to the current operating mode. In the normal AC power supply mode, RC3 (Relay) usually outputs a low level, so that Q1 is off, and Q2 is still in the conductive state.

Battery power supply: when the AC power input voltage is disconnected, the control unit U2 detects the disconnection of the AC power supply through the RC4(AcDet), the base voltage of Q2 becomes low and Q2 is in a cut-off state. The gate voltage of Q3 is pulled up to a high level by R10, and Q3 enters a cut-off mode, terminating AC-derived power supply. When CEN (RA1) is high and the battery voltage is within the normal range (ChargDet detection), the control unit controls ChargSW (RA0) to output a high level to make Q4 conductive; after Q4 conducts, the gate of Q5 is pulled down through the R19-R18 voltage divider network, Q5 conducts, and the battery circuit supplies power to the circuit through D4 and Q5.

Battery discharge test: when it is necessary to conduct a battery discharge test, the control unit U2 first controls CEN(RA1) to output a high level and then controls ChargSW(RA0) to output a high level to ensure that Q5 is conductive, so that the battery circuit supplies power to the circuit. Thereafter, the control unit controls Relay(RC3) to output a high level to make Q6 conductive. After Q6 is conductive, the base of Q7 is pulled low and Q7 is conductive to form a battery discharge path: battery positive terminal-> D4-> Q5-> Q7-> R32-> RC charge/discharge circuit -> ground. The battery is discharged through Q7, R32 and RC charge/discharge circuit. The control unit U2 can assess the battery condition by monitoring the battery voltage during the discharge process (through the ChargDet (RA3) port) and the voltage change of the RC charge/discharge circuit (through the RC (pin 10) port).

The control unit U2 controls the conduction and cutoff of Q1 through the RC3 (Relay) pin. When RC3 (Relay) outputs a high level, Q1 is conductive, pulling down the voltage at the base of Q2, causing Q2 to cut off, which in turn causes Q3 to cut off, cutting off the AC power path. When RC3 (Relay) outputs a low level, Q1 cuts off, the base of Q2 obtains a bias voltage through R11, and Q2 is conductive, which in turn causes Q3 to conduct, and the AC power path is restored. This control mechanism can be used to simulate an AC power failure, to control load on/off, or to implement other specific functions.

The CEN (RA1) signal is used to control the enablement of the battery charge/discharge circuit. When CEN is high, Q4 is allowed to conduct, thus allowing the battery to be discharged or charged; when CEN is low, Q4 is forcibly maintained in the cut-off state regardless of the state of ChargSW(RA0) and ChargDet(RA3), prohibiting the battery from charging or discharging.

### 3. Mode selector switch SW3

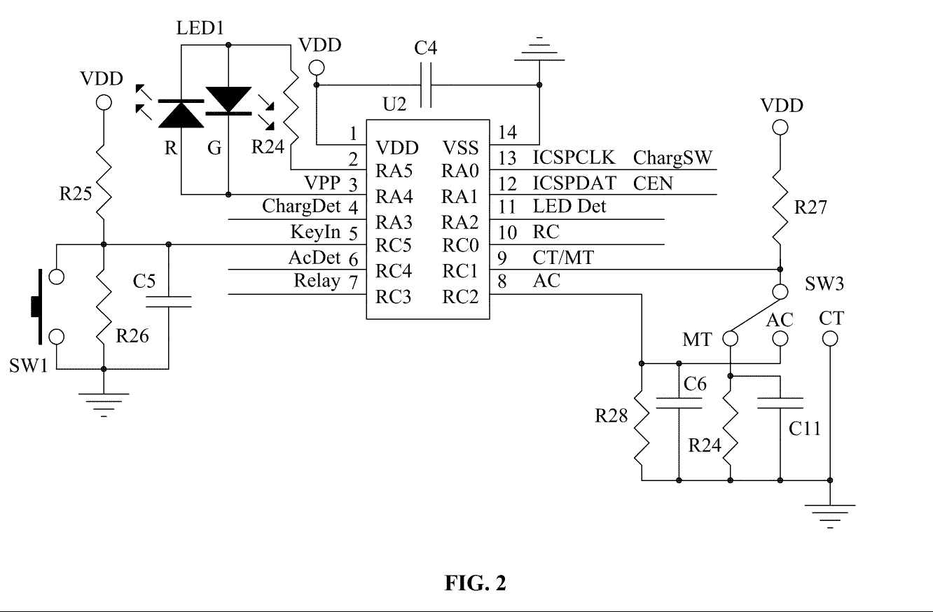

As shown in FIG. 2, the mode selector switch SW3 is a single pole three throw switch with four terminals, corresponding to a continuous test mode terminal (CT), a manual test mode terminal (MT), an AC indication mode terminal (AC), and a common terminal, respectively. Users can select different working modes by toggling the switch.

The common terminal is connected to the RC1 (CT/MT) pin of the control unit U2.

The continuous test mode terminal (CT) is directly grounded. When the switch is turned to this position, the RC1 (CT/MT) pin is pulled to a low level.

The manual test mode terminal (MT) is connected to ground through the resistor R42 and capacitor C11. When SW3 is switched to the MT terminal, the level state of the RC1 (CT/MT) pin is determined by R42 and C11.

The AC indication mode terminal (AC) is connected to the RC2 (AC) pin of the control unit U2 through the resistor R28 and capacitor C6. The RC circuit formed by the resistor R28 and capacitor C6 is used to generate specific level signals or delays for the control unit U2 to detect the AC power status.

### 4. Test unit

As shown in FIGS. 2 and 8, the test unit comprises a detection circuit and a manual test switch.

The detection circuit comprises a resistor divider comprising the resistors R40 and R41. The resistor R41 is disposed between the positive terminal (i.e., VCC) of the emergency indicator unit and the RA2 (LEDDet) pin of the control unit U2, and R40 is disposed between the RA2 (LEDDet) pin of the control unit U2 and ground. The control unit U2 determines the operating status of the emergency indicator unit, i.e., whether the LEDs are lit normally, by detecting the voltage at the RA2 (LEDDet) pin.

One end of the manual test switch SW1 is connected to the RC5 (keyIn) pin of the control unit U2, and the other end is grounded. When the manual test switch SW1 is pressed, the RC5 (keyIn) pin is pulled low, triggering the manual test mode.

### 5. Control unit U2

As shown in FIG. 2, the control unit U2 is a central control hub of the whole circuit, which optionally employs a microcontroller or a programmable logic device. The control unit U2 comprises an internal timer and a plurality of I/O ports.

The timer is used to periodically trigger the battery discharge test and LED status detection in the continuous test mode.

I/O ports:

RA0 (13 pin) ChargeSW, to control the conduction and shutdown of Q4, and to control the charging and discharging of the battery.

RA1 (12 pin) CEN, to control the activation of the battery charging and discharging circuit.

RA2 (11 pin) LEDDet, connected to the LED detection circuit, to detect the status of the LED light.

RA3 (4-pin) ChargeDet, connected to the battery voltage detection circuit, to monitor the battery voltage.

RA4 and RA5 (2-pin), connected to the test result indicator LED1 to indicate the test results.

RC0 (10 pins) RC, connected to the RC charging and discharging circuit, to detect the battery discharge status.

RC1 (9-pin) CT/MT, connected to the common terminal of the mode selector switch SW3, to detect the current working mode.

RC2 (8-pin) AC, connected to the AC terminal of the mode selector switch SW3, to detect the current working mode.

RC3 (7-pin) Relay, to control the on and off of Q1, and to simulate AC power outage and control load on and off.

RC4 (6-pin) AcDet, to check if the AC power supply is working properly.

RC5 (5-pin) keyIn, connected to the manual test switch SW1, to trigger the manual test mode.

### Working modes:

1) Continuous test mode

When the mode selector switch SW3 is set to the continuous test mode terminal (CT), the RC1 (CT/MT) pin is pulled low and the control unit U2 enters the continuous test mode. The control unit U2 performs the following operations periodically according to the settings of the internal timer:

Battery discharge test: the control unit U2 controls CEN (RA1) to output a high level and then controls ChargSW (RA0) to output a high level, which causes Q4 and Q5 to conduct, and the battery circuit supplies power to the circuit. Then the control unit controls Relay(RC3) to output a high level to energize Q6 and Q7 to form a battery discharge path. The battery discharges to the load LED string through Q7, R32 and RC charge/discharge circuit.

LED status detection: in the discharge process or after the discharge, the control unit U2 detects the voltage of the RA2 (LEDDet) pin to determine whether the LED lamp is normally lit. If the LED lamp failure is detected, the control unit U2 controls the test result indicator LED1 to indicate the error.

2) Manual test mode

When the mode selector switch SW3 is set to the manual test (MT) terminal, the RC1 (CT/MT) pin enters a specific logic level state. The control unit U2 detects the manual test mode signal and waits for the manual test switch SW1 to be pressed. When SW1 is pressed, the RC5 (keyIn) pin is pulled low, triggering the control unit U2 to perform the following operations:

Switch to battery power: the control unit U2 drives the CEN (RA1) pin to output a high level and then drives the ChargSW (RA0) pin to output a high level, making the transistors Q4 and Q5 conductive, enabling the battery circuit to power the system.

LED status detection: the control unit U2 checks the voltage at the RA2 (LEDDet) pin to verify whether the LED is functioning properly.

Status indication: the control unit U2 controls the test status indicator LED1 (connected to RA4 and RA5) to present red or green, indicating the test results.

3) AC indication mode

When the mode selector switch SW3 is set to the AC indication mode terminal (AC), the control unit U2 enters the AC indication mode and drives the ChargSW (RA0) pin to output a low level, turning off the transistors Q4 and Q5. This deactivates the battery circuit, ensuring the circuit is powered only by the AC supply for the emergency indicator unit. In addition, the control unit U2 drives the RC3 (Relay) pin to output a low level, ensuring transistor Q1 is cut off (non-conductive). This allows the transistors Q2 and Q3 to conduct, enabling the AC power supply to provide normal power to the circuit.

The specific component parameter values are selected and adjusted according to the actual application requirements. For example, the current-limiting resistor for the LED is chosen based on the rated operating current of the LED; the capacitance value of the filter capacitor is selected according to the operating frequency and noise level of the circuit.

The circuit design provided in this disclosure integrates multiple practical functions and optimizes circuit performance. Compared to existing technologies, the disclosure offers the following significant advantages:

1. Multi-mode flexibility: the circuit supports seamless switching between an auto-test mode, a manual test mode, and an AC indication mode via the mode selector switch SW3, catering to diverse application scenarios. By integrating the three modes, the indicator circuit not only serves as a routine emergency light but also enables streamlined functional testing and maintenance, enhancing operational adaptability and user convenience.

2. Intelligent automated detection: in an automatic detection mode, the control unit U2 leverages its built-in timer to periodically initiate battery discharge tests and LED status checks without manual intervention. This automated detection mechanism significantly enhances detection efficiency, reduces reliance on manual oversight, lowers maintenance costs by preemptively identifying issues, and ensures long-term reliability of the safety indicator system.

3. Simplified manual testing: in a manual test mode, users can quickly trigger battery power activation and LED status verification by pressing the SW1 button. This on-demand testing ensures the functionality of the safety indicator is validated at any time, guaranteeing reliable operation during emergencies.

4. Bi-color indication: the emergency indicator unit features a bi-color LED (red/green) design, equipped with a color toggle switch SW2. This allows users to select the desired indicator color (red or green) based on specific requirements, enhancing warning clarity and adaptability in diverse scenarios.

It will be obvious to those skilled in the art that changes and modifications may be made, and therefore, the aim in the appended claims is to cover all such changes and modifications.

What is claimed is:

1. A multifunctional safety indicator light circuit, comprising:
an emergency indicator unit;
a power supply circuit comprising an AC power input terminal, a battery circuit, a switching circuit for switching power supply between the AC power input terminal and the battery circuit, and a discharging circuit for discharging the battery circuit;
a mode selector switch comprising a continuous test mode terminal, a manual test mode terminal, an AC indication mode terminal, and a common terminal;
a test unit comprising a detection circuit connected to the emergency indicator unit and a manual test switch for manually triggering a test; and
a control unit comprising a timer and a plurality of terminals, the detection circuit and the manual test switch being connected to a first terminal and a second terminal of the control unit, respectively; the common terminal of the mode selector switch being connected to a third terminal of the control unit; and the continuous test mode terminal, the manual test mode terminal, and the AC indication mode terminal being connected to different input pins or specific levels of the control unit, respectively;
wherein,
when the mode selector switch is set to the continuous test mode terminal, the control unit periodically activates the detection circuit through the timer to monitor a status of the emergency indicator light unit;
when the mode selector switch is set to the manual test mode terminal, the control unit, upon detecting a signal from the manual test switch, triggers the switching circuit to shift to battery power and activates the detection circuit to monitor the status of the emergency indicator light unit; and
when the mode selector switch is set to the AC indication mode terminal, the control unit controls the switching circuit to turn off the battery circuit.

2. The circuit of claim 1, wherein
a pull-up resistor is disposed between the third terminal of the control unit and the common terminal of the mode selector switch;
the continuous test mode terminal is grounded;
the AC indication mode terminal is connected to a fourth terminal of the control unit; between the AC indication mode terminal and the fourth terminal of the control unit, a first resistor and a first capacitor are connected in series to ground; and
the manual test mode terminal is electrically connected to the third terminal of the control unit and grounded through a second resistor and a second capacitor connected in series.

3. The circuit of claim 1, wherein
the emergency indicator light unit comprises a plurality of bi-color LED lamps and a color toggle switch;
each of the plurality of bi-color LED lamps comprises a first color end, a second color end, and a first common end;
the color toggle switch comprises a first end, a second end, and a second common end;
the first color end of each of the plurality of bi-color LED lamps is connected to the first end of the color toggle switch;
the second color end of each of the plurality of bi-color LED lamps is connected to the second end of the color toggle switch;
the first common end of each of the plurality of bi-color LED lamps is connected to the power supply circuit; and
the second common end of the color toggle switch is grounded.

4. The circuit of claim 3, wherein each of the bi-color LED lamps comprises a red LED lamp and a green LED lamp, and the red LED lamp and the green LED lamp are operatively connected in series with a current-limiting resistor.

5. The circuit of claim 1, wherein
the switching circuit comprises a first switching element and a second switching element;
the first switching element is operatively coupled to the AC power input terminal and configured to control power supply from the AC power input terminal to the multifunctional safety indicator light circuit;
the second switching element is operatively coupled to the battery circuit and configured to control power supply from the battery circuit to the multifunctional safety indicator light circuit; and
the control unit is programmed to selectively activate or deactivate the first switching element and the second switching element, thereby achieving a power supply switchover between the AC power input terminal and the battery circuit.

6. The circuit of claim 1, wherein
the detection circuit comprises a resistor divider disposed between the emergency indicator unit and ground; and
the first terminal of the control unit is electrically connected to a midpoint node of the resistor divider.

7. The circuit of claim 6, wherein
the resistor divider comprises a third resistor and a fourth resistor;
the third resistor comprise a first end connected to the emergency indicator unit and a second end connected to the first terminal of the control unit; and
the fourth resistor comprise a third end connected to the emergency indicator unit and a fourth end which is grounded.

8. The circuit of claim 5, wherein
both the first switching element and the second switching element are a p-channel metal-oxide-semiconductor field effect transistor (MOSFET);
a source of the first switching element is connected to the AC power input terminal through a first diode, a drain of the first switching element is connected to a power supply terminal of the multifunctional safety indicator light circuit, and a gate of the first switching element is connected to a first control circuit;
a source of the second switching element is connected to a positive terminal of the battery circuit through a second diode, a drain of the second switching element is connected to the power supply terminal of the multifunctional safety indicator light circuit, and a gate of the second switching element is connected to a second control circuit; and
the first control circuit and the second control circuit are configured to activate or deactivate the first switching element and the second switching element, respectively, in response to control signals from the control unit.

9. The circuit of claim 8, wherein
the first control circuit comprises a first NPN transistor; a collector of the first NPN transistor is electrically connected to the gate of the first switching element; an emitter of the first NPN transistor is grounded; and a base of the first NPN transistor is connected via a fifth resistor to both an output terminal of the control unit and the AC power input terminal;
the second control circuit comprises a second NPN transistor; a collector of the second NPN transistor is electrically connected to the gate of the second switching element; an emitter of the second NPN transistor is grounded; a base of the second NPN transistor is connected via a sixth resistor to both the output terminal of the control unit and the positive terminal of the battery circuit;
when a voltage is present at the AC power input terminal, the first NPN transistor is activated, pulling a gate voltage of the first switching element to a low logic level, thereby activating the first switching element, and the AC power input terminal supplies power to the multifunctional safety indicator light via the first diode and the first switching element;
when the AC power input terminal is de-energized, the first NPN transistor is deactivated, pulling the gate voltage of the first switching element up to a high logic level, thereby deactivating the first switching element; and
when the control unit transmits a signal to activate the second NPN transistor, a gate voltage of the second switching element is pulled down to a low logic level, thereby activating the second switching element; and the battery circuit supplies power to the circuit via the second diode and the second switching element.

10. The circuit of claim 8, wherein
the discharging circuit comprises a third switching element disposed between the source of the second switching element and a load, and a fourth switching element for activating or deactivating the third switching element;
a control terminal of the fourth switching element is connected to an output terminal of the control unit, and a control terminal of the third switching element is connected to an output terminal of the fourth switching element through a seventh resistor; and
to discharge the battery circuit, the control unit activates the fourth switching element, thereby activating the third switching element, and a battery discharge path is established.
